(19) United States
(12) Patent Application Publication
(10) Pub. No.: US 2022/0391503 A1
(43) Pub. Date: Dec. 8, 2022

(54) IDENTITY MANAGEMENT ENDPOINT COLLECTION FOR ZERO TRUST SCORE SYSTEM

(71) Applicant: Garret Grajek, Aliso Viejo, CA (US)

(72) Inventor: Garret Grajek, Aliso Viejo, CA (US)

(21) Appl. No.: 17/830,006

(22) Filed: Jun. 1, 2022

Related U.S. Application Data
(60) Provisional application No. 63/195,854, filed on Jun. 2, 2021.

(51) Int. Cl. G06F 21/55; G06F 21/60; G06N 5/02; G06N 20/00

(52) U.S. Cl. CPC G06F 21/554; G06F 21/606; G06F 21/552; G06N 5/025; G06N 20/00

(57) ABSTRACT

A system for auto-attestation of identity and access management (IAM) system is described. In one aspect, a computer-implemented method includes accessing, at a server, identity access management data from the IAM system, forming a log model and a rule model, forming an anomalous detection model, forming a malicious detection model, forming a rule engine, computing an anomalous detection score for an identity event based on the anomalous detection model, computing a malicious detection score for the identity event based on the malicious detection model, computing a rule engine score for the identity event based on the rule engine, calculating a zero trust identity governance and administration (IGA) score for the identity event based on an aggregation of the anomalous detection score, the malicious detection score, and the rule engine score, and determining whether to attest the identity event based on the zero trust IGA score and a threshold score.

The present application claims priority to U.S. Provisional Patent Application Ser. No. 63/195,854, filed Jun. 2, 2021, which is hereby incorporated by reference in its entirety.

### TECHNICAL FIELD

The subject matter disclosed herein generally relates to a special-purpose cloud-based machine that aggregates identity management data for zero trust score system, including computerized variants of such special-purpose machines and improvements to such variants. Specifically, the present disclosure addresses systems and methods for continuous monitoring at the special-purpose cloud-based machine of remote identity management systems and assessing a risk score of the remote identity management systems.

### BACKGROUND

IAM solutions (identity management), PAM solutions (Privilege Access Management), and STEM solutions (Security Information and Event Management) all are deployed into enterprises without much thought on how governance information is to be collected and organized for compliance reports. These reports vary in content (e.g., Health Insurance Portability and Accountability Act (HIPAA) for health care, Service Organization Control 2 (SOC 2) compliance for cloud resources, PCI/DSS for retail, Generate Data Protection Regulation (GDPR) for European Union Privacy). Although the reports vary in content, they all require enterprise information technology (IT) staff to gather information, format the compliance report, and have assigned reviewers sign off on the report.

The conventional process is time consuming and prone to errors. Furthermore, the current Identity Governance and Administration (IGA) and IAM solutions provide no insight on which identity change events are anomalous and/or suspicious to warrant further manual investigation.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 illustrates an example networked environment in accordance with one example embodiment.

FIG. 3 is a block diagram illustrating a scoring system in accordance with one example embodiment.

FIG. 4 illustrates training and use of a machine-learning program, according to some example embodiments.

FIG. 5 is a flow diagram illustrating a method for configuring an attestation system in accordance with one example embodiment.

FIG. 6 illustrates a routine 600 in accordance with one example embodiment.

FIG. 7 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present application describes aggregating identity and access management (IAM) data from an API of a remote IAM system, at a central server that operates a zero trust IGA trust score system (also referred to as IGA scoring system). The IGA scoring system integrates API feeds from auditable events in disparate systems to a centralized audit repository which can feed back into those same systems. The IGA scoring system is a service that listens for events from the remote Identity and Access Management (IAM) system as well as end user applications themselves. The system includes an API connector designed to add users, modify user privileges, delete users and/or change user entitlements in those remote systems.

The IGA scoring system works in conjunction with existing IAM and application API's. The IGA scoring system endpoint (e.g., API connector) listens to IAM activities enacted by the other APIs and/or direct access to the console for IAM changes. One task of the IGA scoring system is to listen to the key changes in the IAM remote system. As such, the IGA scoring system is focused on the attestation of the event—and not the event itself.

In one example, the IGA scoring system API endpoint can be integrated into a variety of solutions that affect identity and security events—these could IAM systems (like Okta, Ping), cloud directory solutions (like Azure AD, JumpCloud), STEM solutions (like AlienVault, Splunk, LogRythm) and PAM solutions (BeyondTrust, CyberArc) among others.

The IGA scoring system can discern what is happening in the remote environment and then to automatically take action based upon any number of risk variables. The dynamic output of the IGA scoring system allows for the change event to happen and audits the event, reverts the change back, or proceeds to contacting an administrator.

The IGA scoring system determines a risk score of an IGA event. This risk score is based on tunable parameters based on both best practices for a trusted IAM system and a logic based (AI or other mechanism) system to determine an anomalous number to help weigh the event. Identity Governance and Administration (IGA) is an important part of any regulated entity. Companies spent millions and sometimes tens of millions of dollars certify their compliance. Unfortunately, most of that money is spent on implementation, administration, located records and logs of key events—and then trying to document their actions on those events. Most important of these events are actions around users: addition, modification and deletions. The most suspicious of changes are attempted to be located and audited. The present application describes an IGA scoring system that remedies the above problem by creating a specific purposed Zero Trust system that integrates into the IAM system (that governs the identity actions).

In one aspect, a computer-implemented method includes accessing, at a server, identity access management data from a remote identity and access management (IAM) system, the access management data includes log data and rule data, the log data indicating identity events, forming a log model based on the log data, forming a rule model based on the rule data, forming an anomalous detection model based on the log model and the identity access management data, forming a malicious detection model based on the rule model and the identity access management data, forming a rule engine based on a manual identification of flagged IAM policies, computing an anomalous detection score for an identity event based on the anomalous detection model, computing a malicious detection score for the identity event based on the malicious detection model, computing a rule engine score for the identity event based on the rule engine, calculating a zero trust identity governance and administration (IGA) score for the identity event based on an aggregation of the anomalous detection score, the malicious detection score, and the rule engine score, and determining whether to attest the identity event based on the zero trust IGA score and a threshold score.

As a result, one or more of the methodologies described herein facilitate solving the technical problem of computer network authentication. As such, one or more of the methodologies described herein may obviate a need for certain efforts or computing resources. Examples of such computing resources include processor cycles, network traffic, memory usage, data storage capacity, power consumption, network bandwidth, and cooling capacity.

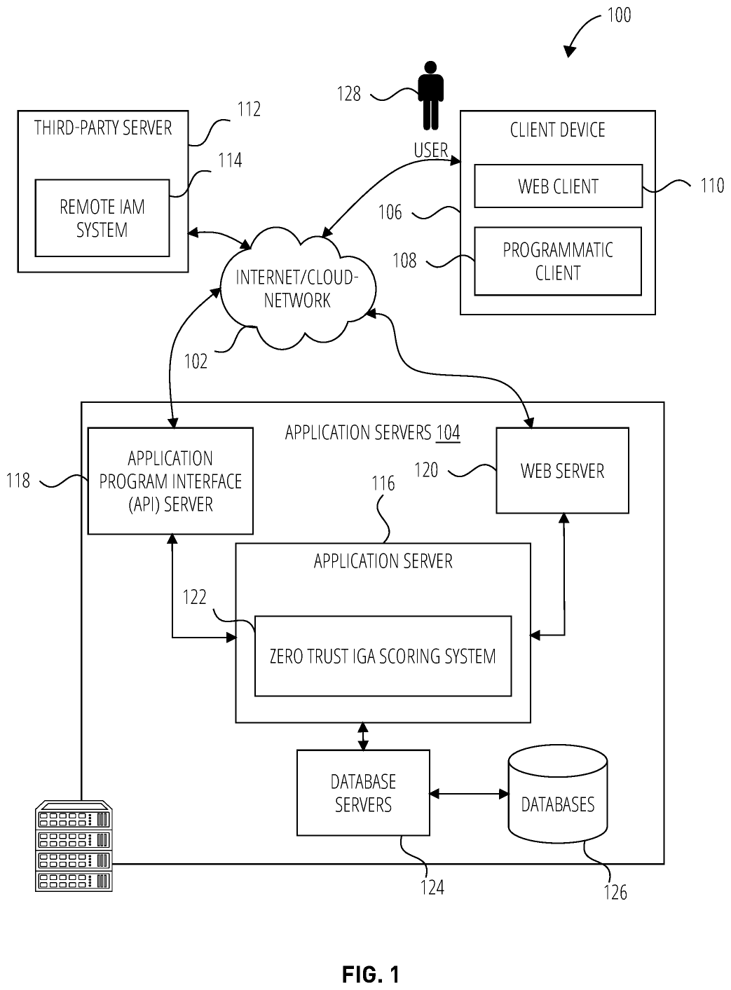

FIG. 1 is a diagrammatic representation of a cloud internet environment 100 in which some example embodiments of the present disclosure may be implemented or deployed. One or more application servers 104 provide server-side functionality via an internet/cloud-network 102 to a networked user device, in the form of a client device 106. A user 128 operates the client device 106. The client device 106 includes a web client 110 (e.g., a browser operating a web version of an enterprise application), a programmatic client 108 (e.g., a client-side enterprise application) that is hosted and executed on the client device 106.

An Application Program Interface (API) server 118 and a web server 120 provide respective programmatic and web interfaces to application servers 104. A specific application server 116 hosts a zero trust IGA scoring system 122. The zero trust IGA scoring system 122 includes components, modules and/or applications.

The zero trust IGA scoring system 122 aggregates data from remote IAM system and generates a scoring based on models. The zero trust IGA scoring system 122 communicates with the programmatic client 108 on the client device 106. For example, the programmatic client 108 includes an administrator application that enables an administrator to configure policies at the zero trust IGA scoring system 122.

The zero trust IGA scoring system 122 communicates with the remote IAM system 114 and aggregates data from the remote IAM system 114. In one example embodiment, the zero trust IGA scoring system 122 trains a machine learning model based on features of the aggregated data from remote IAM system 114. The features may include, for example, policies, access parameters, device identifiers, user identifiers, enterprise identifiers, group identifiers, time stamp, and security events. The zero trust IGA scoring system 122 uses the machine learning model to classify the events as whether to auto-attest or to manually seek a reviewer to attest to the data access compliance. In another example, the zero trust IGA scoring system 122 uses the machine learning model to generate a score based on the aggregate data and the models.

The application server 116 is shown to be communicatively coupled to database servers 124 that facilitates access to an information storage repository or databases 126. In one example embodiment, the databases 126 includes storage devices that store documents to be processed by the zero trust IGA scoring system 122. For example, the databases 126 include a library of events (e.g., device identifiers, user identifiers, enterprise identifiers, group identifiers, time stamp, and security events) and a library of machine learning models.

Additionally, a remote IAM system 114 executing on a third-party server 112, is shown as having programmatic access to the application server 116 via the programmatic interface provided by the Application Program Interface (API) server 118. For example, the remote IAM system 114, using information retrieved from the application server 116, may supports one or more features or functions on a website hosted by the third party. In another example, the remote IAM system 114 computes the trust score.

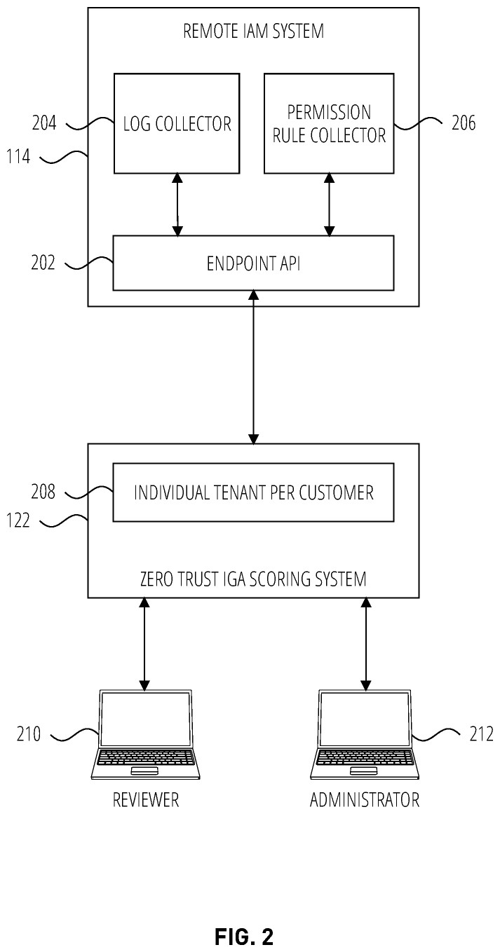

FIG. 2 illustrates an example networked environment in accordance with one example embodiment. The networked environment comprises a remote IAM system 114, a zero trust IGA scoring system 122, a reviewer client device 210, and an administrator client device 212.

The remote IAM system 114 includes a log collector 204, a permission rule collector 206, and an endpoint API 202. The remote IAM system 114 includes a self-standing, pre-existing system: usually a cloud-based Identity and Access Management system that contains users, roles, permission, 2-factor and SSO into applications.

The endpoint API 202 is designed to catch any and all identity events. The endpoint API 202 detects changes performed/requested on the remote IAM system 114 and events triggered by API to the remote IAM system 114.

The log collector 204 is a one-time data log collector that the zero trust IGA scoring system 122 executes on the remote IAM system 114 to gather as much past identity events/logs information as possible. The permission rule collector 206 is a one-time collector that the zero trust IGA scoring system 122 execute on the remote IAM system 114 to gather as much past identity event permission information as possible.

The zero trust IGA scoring system 122 includes a centralized system (e.g., cloud-based server). In one example, the zero trust IGA scoring system 122 includes an individual tenant per customer 208.

The zero trust IGA scoring system 122 supports multiple administrators and the privilege-delineated administrators of the remote IAM system 114 (e.g., administrator client device 212). The zero trust IGA scoring system 122 communicating with reviewer client device 210 to run attestation campaigns against the changes for users and application access reviews.

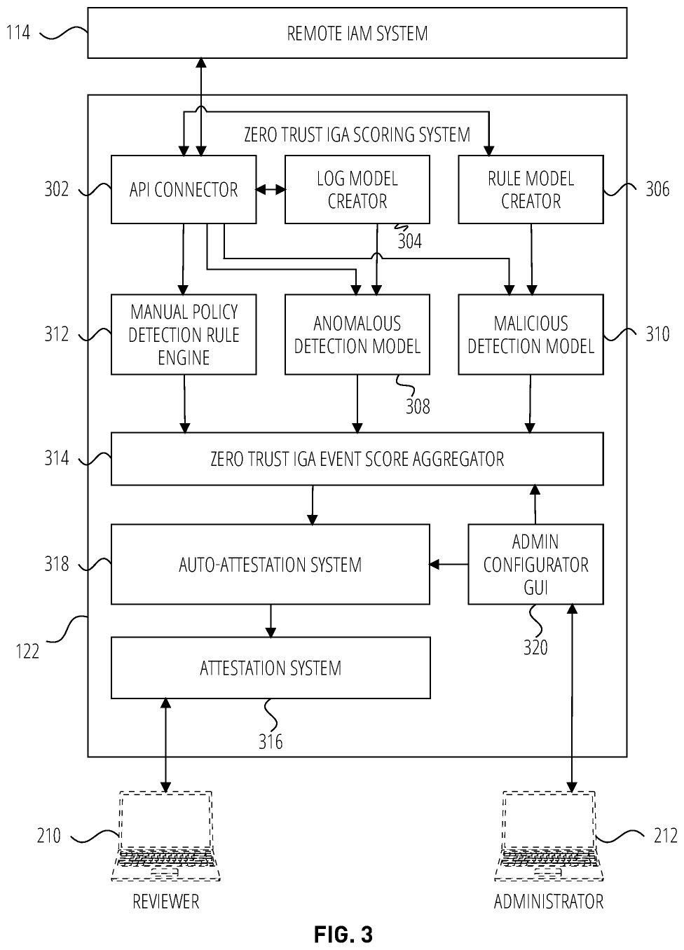

FIG. 3 is a block diagram illustrating a zero trust IGA scoring system 122 in accordance with one example embodiment. The zero trust IGA scoring system 122 includes an API connector 302, a log model creator 304, a rule model creator 306, an anomalous detection model 308, a malicious detection model 310, a manual policy detection rule engine 312, a zero trust IGA event score aggregator 314, an attestation system 316, an auto-attestation system 318, an admin configurator GUI 320.

The API connector 302 includes, for example, a receptor to endpoint API 202 from the remote IAM system 114. The API connector 302 accept the API inputs from the remote IAM system 114. In one example, the API connector 302 accesses data from the remote IAM system 114 via the API connector 302. The data collected includes, for example, log data (e.g., identity role changes (user, group, manager) application assignment data) and rule data (e.g., current rules, policies and permissions) from the remote IAM system 114.

The log model creator 304 includes a log model. In one example, the log model creator 304 trains a machine learning model based on log data (e.g., previous identity events) from the API connector 302.

The rule model creator 306 includes a rule model. In one example, the rule model creator 306 trains a machine learning model based on the current rules, policies, and permissions from the remote IAM system 114.

The anomalous detection model 308 includes a trained model based on the log data and the log model. The anomalous detection model 308 creates an identity event trust score on a new identity event based on previous events.

The malicious detection model 310 includes a trained model created from the existing rules and policies. The malicious detection model 310 creates a rule trust score based on the new policy compared to previous policies.

The manual policy detection rule engine 312 includes a Segregation of Duties (SoD) rules created to identify potentially malicious and suspicious events which will trigger an SoD violation. These SoD rules can be triggered within the zero trust IGA scoring system 122 based upon any combination of directory group membership (AD, LDAP, Okta, jumpcloud), application assignment, external risk indicators, origination of data or a combination of manual numeric values. In one example, the manual policy detection rule engine 312 generates a manual policy score based on the type of event detected.

An example is a user has recently had a title change yet still required access to a system assigned to their previous roles. Once the zero trust IGA scoring system 122 is alerted to the change in access, the new assignment will be calculated into a total overall risk score. If this new assignment results in an unusually high calculated risk score, then the change could be reverted and a notification sent. If the calculated risk score is below the set threshold, then a certification event is created within zero trust IGA scoring system 122 and assigned to a reviewer (e.g., reviewer client device 210).

The zero trust IGA event score aggregator 314 includes an aggregator engine that intakes the scores from the manual policy detection rule engine 312, anomalous detection model 308, and malicious detection model 310. For example, the zero trust IGA event score aggregator 314 aggregates the manual policy score from manual policy detection rule engine 312, the identity event score from the anomalous detection model 308, and the manual policy score from the malicious detection model 310. The added score is referred to as a Zero Trust score for the IGA event.

The auto-attestation system 318 includes a configurable GUI controls the automated attestations campaigns. The GUI allows zero trust IGA scoring system 122 admins (e.g., administrator client device 212) to set Zero Trust thresholds which would kick off attestation campaigns of the identity event.

The attestation system 316 includes an integrated access review system (NIST SP 800-53 rev 5, PR.AC-4) that allows enterprise to have multiple reviewers review access rights. The attestation system 316 attests the change for compliance and meeting regulatory requirements.

The admin configurator GUI 320 provides a GUI for the administrator client device 212 to perform a set of actions such as: User Additions, Role Changes, Group Changes, Permissions Granted, User Deletes. Examples of APIs to other systems for: 2-Factor authentication and Syslog output to STEM.

The following describes an example operation of the zero trust IGA scoring system 122:

### Step #1: Pre-Processing Phase

The zero trust IGA scoring system 122 applies a set of collectors to obtain baseline information of the remote IAM system 114 study to be scored.

These collectors could include:
A log collector of past changes, deletions and modifications of the remote IAM system 114 for the domain(s) that will be analyzed
A baseline collector of current permissions, roles, users, groups, etc

These collectors would create this data that can be gathered into CSV or other data recording format for export and import into the zero trust IGA scoring system 122—or a direct API would be configured to the zero trust IGA scoring system 122.

### Step #2: Models and Rule Generation at the Centralized Zero Trust IGA Scoring System 122

The zero trust IGA scoring system 122 includes a multi-tenanted cloud based system which has a dedicated model and set of rules for each customer and IAM system. (A customer can have multiple, disparate IAM systems—each would require a separate set of models and rules). A change model is created at this time off of the logs pulled from the remote IAM system 114. This change model might also include the baseline file of permissions and rules.

The model includes an unsupervised model or a supervised model. The unsupervised model is created by taking the data from the previous changes. If enough changes are not available from the logs additional data could by applying listeners to the remote IAM system 114 and collecting data for a period of time.

An supervised model is created instead or in addition to the unsupervised model. This model includes a set of the changes—plus the baseline of current roles and permissions to help identify anomalies and actions that are vastly different from the current state and from pervious changes.

In one example embodiment, the log model creator 304, rule model creator 306, anomalous detection model 308, and malicious detection model 310 utilize both a supervised and unsupervised model in conjunction. In addition, multiple individual models may be utilized to process data and the output fed to a meta-model that will weigh the individual outputs and then process the weights accordingly to a final score.

In another example embodiment, the anomalous detection model 308 and malicious detection model 310 include a weighing of a main model combined with weighted values that are triggered from the rules engine. The two scores are combined to create a Zero Trust “trust value” for the change in permission.

Step #3: Integration of the Zero Trust IGA Scoring System 122 into the Remote IAM System 114

One objective is to obtain real time IAM events from the remote IAM system 114 and review the different types of input immediately in the zero trust IGA scoring system 122. To meet this objective the zero trust IGA scoring system 122 connects to the different IAM systems directly via API (e.g., API connector 302).

The following types of events can be pulled from the remote IAM system 114:

Remote Application Lifecycle Events

Remote User CRUD Events

Remote Access Events

Remote Device Trust/Endpoint Events

Remote Security Events

Remote Import Event

Remote Policy Events

Remote Group Events

User Allocation Events

Remote User Authentication Events

Risk Scores from remote systems

These events are sent to the zero trust IGA scoring system 122 usually with some type of administrator configured API integration. In one example, the API connector 302/endpoint API 202 has the ability to throttle events and to only send a subset of events. The API connector 302/endpoint API 202 could also collate events and send in a scheduled and acceptable interval with packaged packets of information.

### Step #4: Accept the Real-Time Event and Calculate a Real Time Zero Trust IGA Score

The relevant tenant of the zero trust IGA scoring system 122 consumes these events. An API connector 302 listens/polls for events. The events would be delivered to the proper AI model or models (e.g., log model creator 304, rule model creator 306, anomalous detection model 308, malicious detection model 310). For example, if the event is an “additional application authorization for user” event, then an appropriate model such as the “User Permission” AI model would be for this event.

In addition, the event is fed to either a malicious AI model (e.g., malicious detection model 310) and/or or malicious rule engine. The malicious detection model 310 includes a supervised model that is aware of privilege escalation events and circumstances around the events. The same type of information could be formulated around a rules-based engine that had hand-crafted rules that were coded to understand and identify malicious events.

Depending on which models and rule sets are triggered, the event is processed by a centralized aggregation processing unit (e.g., zero trust IGA event score aggregator 314). The zero trust IGA event score aggregator 314 processes the event in real time and produces a score. For example, the score can be a number between zero and 100, with zero being untrusted and 100 being the most trusted. This score is available to the remote IAM system 114.

### Step #5: Auto-Attestation of the Real-Time IGA Trust Score

The zero trust IGA scoring system 122 collects the IAM changes, runs the change through both models and rules based on historical activities and known S.O.D. (segregation of duties violations). The zero trust IGA scoring system 122 further executes built-in auto-attestations (e.g., auto-attestation system 318). The auto-attestation system 318 forces selected people or groups in the organization to acknowledge and approve the change.

For example, the auto-attestation system 318 generates real time attestations of the event. That is zero trust IGA scoring system 122 instructs enterprises to pre-configure which users are to attest to the IAM changes. In addition, the reviewers of the changes can be subdivided based on either user groups, application ownership and/or other event categories. In one example, the auto-attestation system 318 includes a configurable console that generates a mandatory attestation of an event based on the real-time, zero trust IGA score.

The auto-attestations are available through the standard attestation system (e.g., attestation system 316) which the reviewers (e.g., reviewer client device 210) are notified and then can execute on their review. The attestation system 316 tabulates all the reviews and show the result in a console. The attestation system 316 can send reminders to the reviewer client device 210 to ensure that the reviews are executed.

The attestation system 316 records each attestation (e.g., the event, the time, the reviewers response and any notes from the reviewer). All this information is retrievable by users of the zero trust IGA scoring system 122 by internal and external auditors searchable on events, time and other parameters.

### Step #6: External Utilization of the Real-Time IGA Trust Score

The zero trust IGA scoring system 122 can provide the real time Zero Trust IGA score available to the following resources:

SIEMs (Security Information and event management)

IAMs (the originating source)

SOAR (Security Orchestration, Automation and Response)

In one example, the zero trust IGA scoring system 122 includes a Real-Time IGA trust score transfer system (e.g., a REST API or some other mechanism). One aspect of the present application is a forced attestation from the resulting zero trust score from the data collected and scored by the ML models and rules.

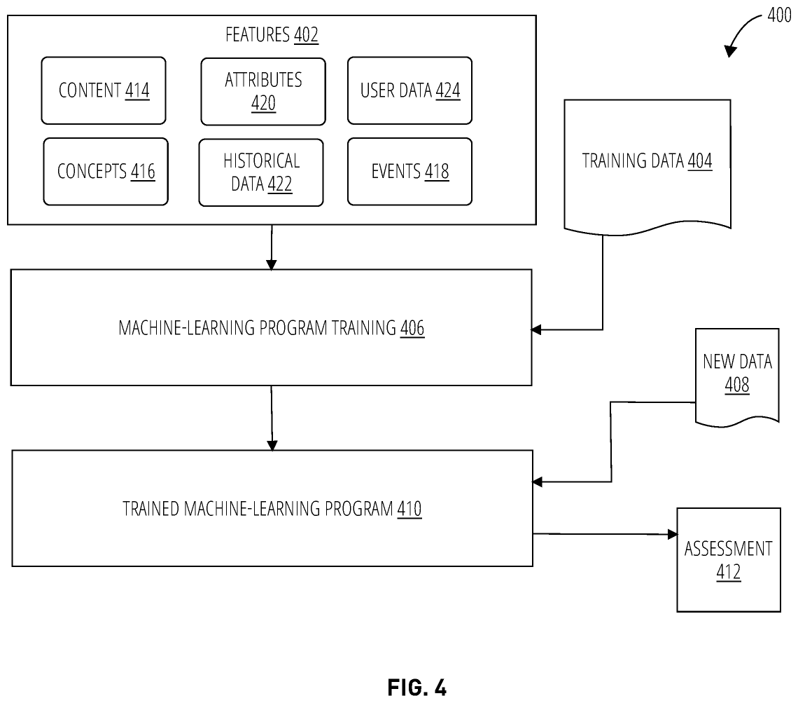

FIG. 4 illustrates training and use of a machine-learning program 400, according to some example embodiments. In some example embodiments, machine-learning programs (MLPs), also referred to as machine-learning algorithms or tools, are used to perform operations associated with searches, such as job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 404 (e.g., events) in order to make data-driven predictions or decisions expressed as outputs or assessments (e.g., assessment 412—such as computing a trust score of the user 128). Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, suspicious user or trusted user). Regression algorithms aim at quantifying some items (for example, by providing a value that is a real number such as a trust score).

The machine-learning algorithms use features 402 for analyzing the data to generate an assessment 412. Each of the features 402 is an individual measurable property of a phenomenon being observed. The concept of a feature is related to that of an explanatory variable used in statistical techniques such as linear regression. Choosing informative, discriminating, and independent features is important for the effective operation of the MLP in pattern recognition, classification, and regression. Features may be of different types, such as numeric features, strings, and graphs.

In one example embodiment, the features 402 may be of different types and may include one or more of content 414, events 418 (e.g., device identifiers, user identifiers, enterprise identifiers, group identifiers, time stamp, and security events), concepts 416, attributes 420, historical data 422 and/or user data 424 (e.g., user-profile), merely for example.

The machine-learning algorithms use the training data 404 to find correlations among the identified features 402 that affect the outcome or assessment 412. In some example embodiments, the training data 404 includes labeled data, which is known data for one or more identified features 402 and one or more outcomes, such as detecting an anomalous behavior of the user 128, calculating a trust score, etc.

With the training data 404 and the identified features 402, the machine-learning tool is trained at machine-learning program training 406. The machine-learning tool appraises the value of the features 402 as they correlate to the training data 404. The result of the training is the trained machine-learning program 410.

When the trained machine-learning program 410 is used to perform an assessment, new data 408 (e.g., new events) is provided as an input to the trained machine-learning program 410, and the trained machine-learning program 410 generates the assessment 412 (e.g., suspicious user, trusted user) as output.

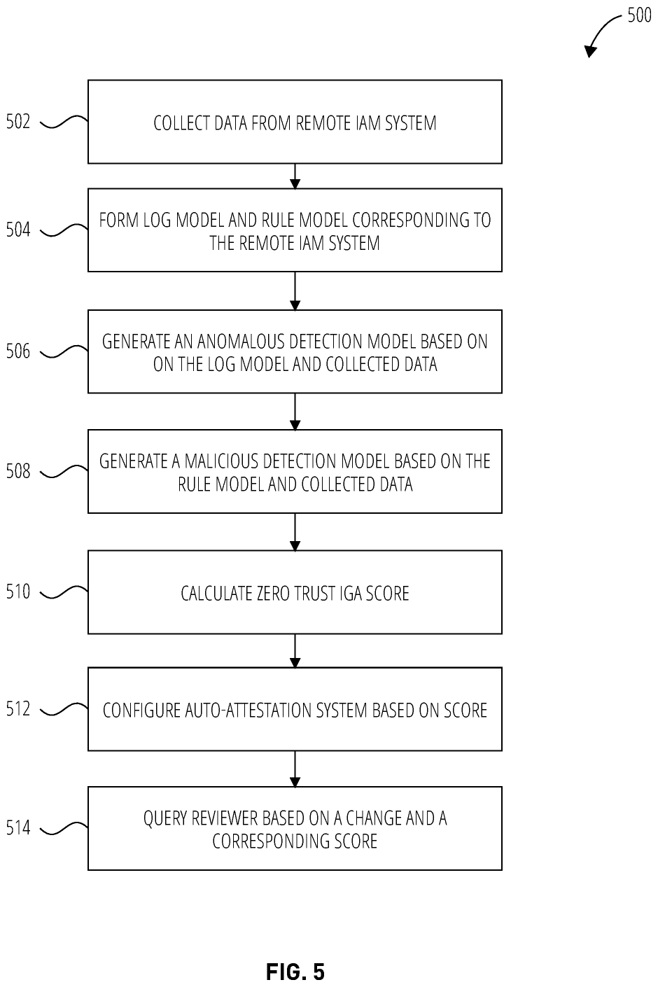

FIG. 5 is a flow diagram illustrating a method 500 for configuring an attestation system in accordance with one example embodiment. Operations in the method 500 may be performed by the zero trust IGA scoring system 122, using components (e.g., modules, engines) described above with respect to FIG. 3. Accordingly, the method 500 is described by way of example with reference to the zero trust IGA scoring system 122. However, it shall be appreciated that at least some of the operations of the method 500 may be deployed on various other hardware configurations or be performed by similar components residing elsewhere. For example, some of the operations may be performed at the client device 106.

In block 502, the API connector 302 collects data from the remote IAM system 114. In block 504, the log model creator 304 forms log model and the rule model creator 306 forms rule model corresponding to the remote IAM system 114. In block 506, the anomalous detection model 308 generates an anomalous detection model based on the log model and collected data. In block 508, the malicious detection model 310 generates a malicious detection model based on the rule model and collected data. In block 510, the zero trust IGA event score aggregator 314 calculates a zero trust IGA score. In block 512, the auto-attestation system 318 configures auto-attestation system based on a comparison of the score with a preset threshold score. In block 514, the attestation system 316 queries a reviewer client device 210 based on a change (e.g., detected event) and a corresponding score.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

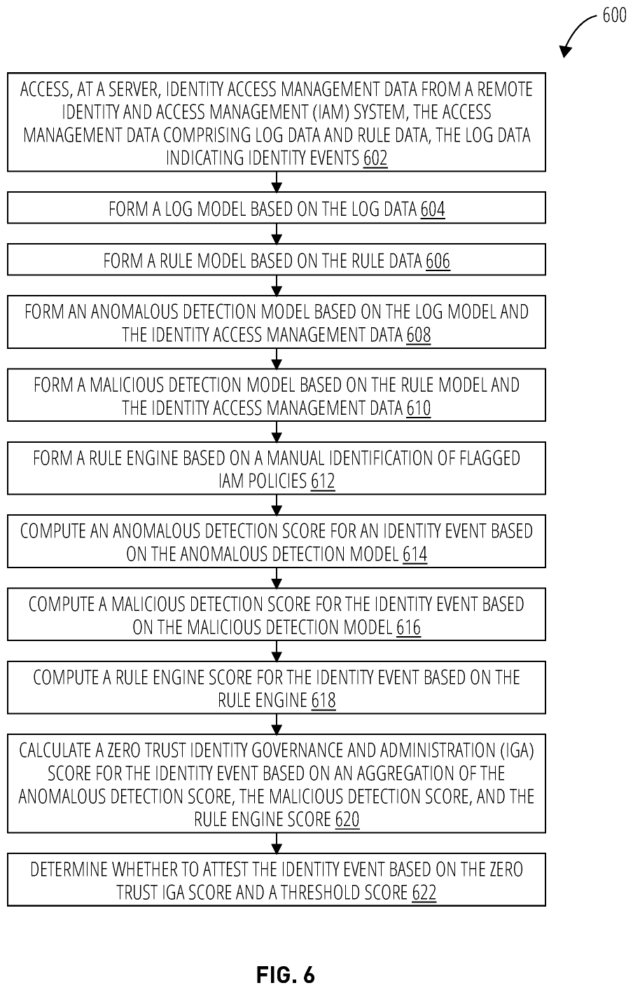

FIG. 6 illustrates a routine 600 in accordance with one example embodiment. In block 602, routine 600 accesses, at a server, identity access management data from a remote identity and access management (IAM) system, the access management data comprising log data and rule data, the log data indicating identity events. In block 604, routine 600 forms a log model based on the log data. In block 606, routine 600 forms a rule model based on the rule data. In block 608, routine 600 forms an anomalous detection model based on the log model and the identity access management data. In block 610, routine 600 forms a malicious detection model based on the rule model and the identity access management data. In block 612, routine 600 forms a rule engine based on a manual identification of flagged IAM policies. In block 614, routine 600 computes an anomalous detection score for an identity event based on the anomalous detection model. In block 616, routine 600 computes a malicious detection score for the identity event based on the malicious detection model. In block 618, routine 600 computes a rule engine score for the identity event based on the rule engine. In block 620, routine 600 calculates a zero trust identity governance and administration (IGA) score for the identity event based on an aggregation of the anomalous detection score, the malicious detection score, and the rule engine score. In block 622, routine 600 determines whether to attest the identity event based on the zero trust IGA score and a threshold score.

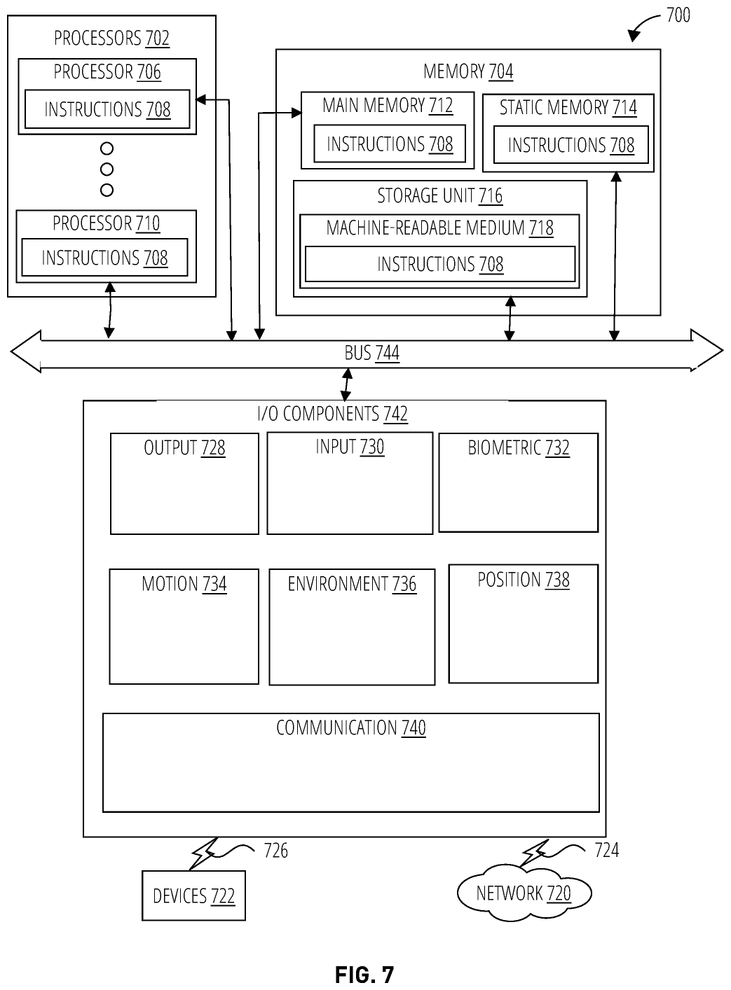

FIG. 7 is a diagrammatic representation of the machine 700 within which instructions 708 (e.g., software, a program, an application, an applet, an app, or other executable code) for causing the machine 700 to perform any one or more of the methodologies discussed herein may be executed. For example, the instructions 708 may cause the machine 700 to execute any one or more of the methods described herein. The instructions 708 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 708, sequentially or otherwise, that specify actions to be taken by the machine 700. Further, while only a single machine 700 is illustrated, the term “machine” shall also be taken to include a collection of machines that individually or jointly execute the instructions 708 to perform any one or more of the methodologies discussed herein.

The machine 700 may include Processors 702, memory 704, and I/O Components 742, which may be configured to communicate with each other via a bus 744. In an example embodiment, the Processors 702 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 706 and a Processor 710 that execute the instructions 708. The term “Processor” is intended to include multi-core processors that may comprise two or more independent processors (sometimes referred to as “cores”) that may execute instructions contemporaneously. Although FIG. 7 shows multiple Processors 702, the machine 700 may include a single Processor with a single core, a single Processor with multiple cores (e.g., a multi-core Processor), multiple processors with a single core, multiple processors with multiples cores, or any combination thereof.

The memory 704 includes a main memory 712, a static memory 714, and a storage unit 716, both accessible to the Processors 702 via the bus 744. The main memory 704, the static memory 714, and storage unit 716 store the instructions 708 embodying any one or more of the methodologies or functions described herein. The instructions 708 may also reside, completely or partially, within the main memory 712, within the static memory 714, within machine-readable medium 718 within the storage unit 716, within at least one of the Processors 702 (e.g., within the Processor's cache memory), or any suitable combination thereof, during execution thereof by the machine 700.

The I/O Components 742 may include a wide variety of components to receive input, provide output, produce output, transmit information, exchange information, capture measurements, and so on. The specific I/O Components 742 that are included in a particular machine will depend on the type of machine. For example, portable machines such as mobile phones may include a touch input device or other such input mechanisms, while a headless server machine will likely not include such a touch input device. It will be appreciated that the I/O Components 742 may include many other components that are not shown in FIG. 7. In various example embodiments, the I/O Components 742 may include output Components 728 and input Components 730. The output Components 728 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input Components 730 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O Components 742 may include biometric Components 732, motion Components 734, environmental Components 736, or position Components 738, among a wide array of other components. For example, the biometric Components 732 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 734 include acceleration sensor components (e.g., accelerometer), gravitation sensor components, rotation sensor components (e.g., gyroscope), and so forth. The environmental Components 736 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position Components 738 include location sensor components (e.g., a GPS receiver Component), altitude sensor components (e.g., altimeters or barometers that detect air pressure from which altitude may be derived), orientation sensor components (e.g., magnetometers), and the like.

Communication may be implemented using a wide variety of technologies. The I/O Components 742 further include communication Components 740 operable to couple the machine 700 to a network 720 or devices 722 via a coupling 724 and a coupling 726, respectively. For example, the communication Components 740 may include a network interface Component or another suitable device to interface with the network 720. In further examples, the communication Components 740 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 722 may be another machine or any of a wide variety of peripheral devices (e.g., a peripheral device coupled via a USB).

Moreover, the communication Components 740 may detect identifiers or include components operable to detect identifiers. For example, the communication Components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication Components 740, such as location via Internet Protocol (IP) geolocation, location via Wi-Fi® signal triangulation, location via detecting an NFC beacon signal that may indicate a particular location, and so forth.

The various memories (e.g., memory 704, main memory 712, static memory 714, and/or memory of the Processors 702) and/or storage unit 716 may store one or more sets of instructions and data structures (e.g., software) embodying or used by any one or more of the methodologies or functions described herein. These instructions (e.g., the instructions 708), when executed by Processors 702, cause various operations to implement the disclosed embodiments.

The instructions 708 may be transmitted or received over the network 720, using a transmission medium, via a network interface device (e.g., a network interface Component included in the communication Components 740) and using any one of a number of well-known transfer protocols (e.g., hypertext transfer protocol (HTTP)). Similarly, the instructions 708 may be transmitted or received using a transmission medium via the coupling 726 (e.g., a peer-to-peer coupling) to the devices 722.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

### EXAMPLES

Example 1 is a computer-implemented method comprising: accessing, at a server, identity access management data from a remote identity and access management (IAM) system, the access management data comprising log data and rule data, the log data indicating identity events; forming a log model based on the log data; forming a rule model based on the rule data; forming an anomalous detection model based on the log model and the identity access management data; forming a malicious detection model based on the rule model and the identity access management data; forming a rule engine based on a manual identification of flagged IAM policies; computing an anomalous detection score for an identity event based on the anomalous detection model; computing a malicious detection score for the identity event based on the malicious detection model; computing a rule engine score for the identity event based on the rule engine; calculating a zero trust identity governance and administration (IGA) score for the identity event based on an aggregation of the anomalous detection score, the malicious detection score, and the rule engine score; and determining whether to attest the identity event based on the zero trust IGA score and a threshold score.

Example 2 includes the computer-implemented method of example 1, further comprising: determining that the zero trust IGA score transgresses the threshold score; and in response to determining that the zero trust IGA score transgresses the threshold score, attesting the identity event.

Example 3 includes the computer-implemented method of example 1, further comprising: determining that the zero trust IGA score transgresses the threshold score; in response to determining that the zero trust IGA score transgresses the threshold score, identifying an access right-reviewer user based on the identity event; and querying a client device of the access right-reviewer user to confirm the identity event.

Example 4 includes the computer-implemented method of example 3, further comprising: receiving a confirmation of the identity event; and storing the confirmation of the identity event, a log of the confirmation, and the identity event in a storage of the server.

Example 5 includes the computer-implemented method of example 1, further comprising: providing an administrator configuration user interface to a client device of an administrator of the IAM system, wherein the administrator configuration user interface enables the administrator to add users, change user roles, change user groups, grant rights permissions, or delete users.

Example 6 includes the computer-implemented method of example 1, wherein the log data comprises: log history data of changes, deletions, and modification of the IAM system; and baseline data indicating current permissions, roles, users, and groups for the IAM system.

Example 7 includes the computer-implemented method of example 6, wherein forming the anomalous detection model comprises: forming an unsupervised or supervised model based the log history data and the baseline data.

Example 8 includes the computer-implemented method of example 6, wherein forming the malicious detection model comprises: forming an unsupervised or supervised model based the log history data and the baseline data.

Example 9 includes the computer-implemented method of example 1, further comprising an endpoint API receptor module configured to receive all identity events from the IAM system.

Example 10 includes the computer-implemented method of example 9, wherein the endpoint API receptor module is configured to throttle identity events from the IAM system, or to access a package of identity events from the IAM system on a scheduled periodic time interval.

Example 11 is a cloud-based computing apparatus comprising: a processor; and a memory storing instructions that, when executed by the processor, configure the apparatus to: access, at a server, identity access management data from a remote identity and access management (IAM) system, the access management data comprising log data and rule data, the log data indicating identity events; form a log model based on the log data; form a rule model based on the rule data; form an anomalous detection model based on the log model and the identity access management data; form a malicious detection model based on the rule model and the identity access management data; form a rule engine based on a manual identification of flagged IAM policies; compute an anomalous detection score for an identity event based on the anomalous detection model; compute a malicious detection score for the identity event based on the malicious detection model; compute a rule engine score for the identity event based on the rule engine; calculate a zero trust identity governance and administration (IGA) score for the identity event based on an aggregation of the anomalous detection score, the malicious detection score, and the rule engine score; and determine whether to attest the identity event based on the zero trust IGA score and a threshold score.

Example 12 includes the computing apparatus of example 11, wherein the instructions further configure the apparatus to: determine that the zero trust IGA score transgresses the threshold score; and in response to determining that the zero trust IGA score transgresses the threshold score, attest the identity event.

Example 13 includes the computing apparatus of example 11, wherein the instructions further configure the apparatus to: determine that the zero trust IGA score transgresses the threshold score; in response to determining that the zero trust IGA score transgresses the threshold score, identify an access right-reviewer user based on the identity event; and query a client device of the access right-reviewer user to confirm the identity event.

Example 14 includes the computing apparatus of example 13, wherein the instructions further configure the apparatus to: receive a confirmation of the identity event; and store the confirmation of the identity event, a log of the confirmation, and the identity event in a storage of the server.

Example 15 includes the computing apparatus of example 11, wherein the instructions further configure the apparatus to: provide an administrator configuration user interface to a client device of an administrator of the IAM system, wherein the administrator configuration user interface enables the administrator to add users, change user roles, change user groups, grant rights permissions, or delete users.

Example 16 includes the computing apparatus of example 11, wherein the log data comprises: log history data of changes, deletions, and modification of the IAM system; and baseline data indicate current permissions, roles, users, and groups for the IAM system.

Example 17 includes the computing apparatus of example 16, wherein forming the anomalous detection model comprises: form an unsupervised or supervised model based the log history data and the baseline data.

Example 18 includes the computing apparatus of example 16, wherein forming the malicious detection model comprises: form an unsupervised or supervised model based the log history data and the baseline data.

Example 19 includes the computing apparatus of example 11, wherein the instructions further configure the apparatus to an endpoint API receptor module configured to receive all identity events from the IAM system.

Example 20 is a non-transitory computer-readable storage medium, the computer-readable storage medium including instructions that when executed by a computer, cause the computer to: access, at a server, identity access management data from a remote identity and access management (IAM) system, the access management data comprising log data and rule data, the log data indicating identity events; form a log model based on the log data; form a rule model based on the rule data; form an anomalous detection model based on the log model and the identity access management data; form a malicious detection model based on the rule model and the identity access management data; form a rule engine based on a manual identification of flagged IAM policies; compute an anomalous detection score for an identity event based on the anomalous detection model; compute a malicious detection score for the identity event based on the malicious detection model; compute a rule engine score for the identity event based on the rule engine; calculate a zero trust identity governance and administration (IGA) score for the identity event based on an aggregation of the anomalous detection score, the malicious detection score, and the rule engine score; and determine whether to attest the identity event based on the zero trust IGA score and a threshold score.

What is claimed is:

1. A computer-implemented method comprising:
accessing, at a server, identity access management data from a remote identity and access management (IAM) system, the access management data comprising log data and rule data, the log data indicating identity events;
forming a log model based on the log data;
forming a rule model based on the rule data;
forming an anomalous detection model based on the log model and the identity access management data;
forming a malicious detection model based on the rule model and the identity access management data;
forming a rule engine based on a manual identification of flagged IAM policies;
computing an anomalous detection score for an identity event based on the anomalous detection model;
computing a malicious detection score for the identity event based on the malicious detection model;
computing a rule engine score for the identity event based on the rule engine;
calculating a zero trust identity governance and administration (IGA) score for the identity event based on an aggregation of the anomalous detection score, the malicious detection score, and the rule engine score; and
determining whether to attest the identity event based on the zero trust IGA score and a threshold score.

2. The computer-implemented method of claim 1, further comprising:
determining that the zero trust IGA score transgresses the threshold score; and
in response to determining that the zero trust IGA score transgresses the threshold score, attesting the identity event.

3. The computer-implemented method of claim 1, further comprising:
determining that the zero trust IGA score transgresses the threshold score;
in response to determining that the zero trust IGA score transgresses the threshold score, identifying an access right-reviewer user based on the identity event; and
querying a client device of the access right-reviewer user to confirm the identity event.

4. The computer-implemented method of claim 3, further comprising:
receiving a confirmation of the identity event; and
storing the confirmation of the identity event, a log of the confirmation, and the identity event in a storage of the server.

5. The computer-implemented method of claim 1, further comprising:
providing an administrator configuration user interface to a client device of an administrator of the IAM system,
wherein the administrator configuration user interface enables the administrator to add users, change user roles, change user groups, grant rights permissions, or delete users.

6. The computer-implemented method of claim 1, wherein the log data comprises:
log history data of changes, deletions, and modification of the IAM system; and
baseline data indicating current permissions, roles, users, and groups for the IAM system.

7. The computer-implemented method of claim 6, wherein forming the anomalous detection model comprises:
forming an unsupervised or supervised model based the log history data and the baseline data.

8. The computer-implemented method of claim 6, wherein forming the malicious detection model comprises:
forming an unsupervised or supervised model based the log history data and the baseline data.

9. The computer-implemented method of claim 1, further comprising an endpoint API receptor module configured to receive all identity events from the IAM system.

10. The computer-implemented method of claim 9, wherein the endpoint API receptor module is configured to throttle identity events from the IAM system, or to access a package of identity events from the IAM system on a scheduled periodic time interval.

11. A cloud-based computing apparatus comprising:
a processor; and
a memory storing instructions that, when executed by the processor, configure the apparatus to:
access, at a server, identity access management data from a remote identity and access management (IAM) system, the access management data comprising log data and rule data, the log data indicating identity events;
form a log model based on the log data;
form a rule model based on the rule data;
form an anomalous detection model based on the log model and the identity access management data;
form a malicious detection model based on the rule model and the identity access management data;
form a rule engine based on a manual identification of flagged IAM policies;
compute an anomalous detection score for an identity event based on the anomalous detection model;
compute a malicious detection score for the identity event based on the malicious detection model;
compute a rule engine score for the identity event based on the rule engine;
calculate a zero trust identity governance and administration (IGA) score for the identity event based on an aggregation of the anomalous detection score, the malicious detection score, and the rule engine score; and
determine whether to attest the identity event based on the zero trust IGA score and a threshold score.

12. The computing apparatus of claim 11, wherein the instructions further configure the apparatus to:
determine that the zero trust IGA score transgresses the threshold score; and
in response to determining that the zero trust IGA score transgresses the threshold score, attest the identity event.

13. The computing apparatus of claim 11, wherein the instructions further configure the apparatus to:
determine that the zero trust IGA score transgresses the threshold score;
in response to determining that the zero trust IGA score transgresses the threshold score, identify an access right-reviewer user based on the identity event; and
query a client device of the access right-reviewer user to confirm the identity event.

14. The computing apparatus of claim 13, wherein the instructions further configure the apparatus to:
receive a confirmation of the identity event; and
store the confirmation of the identity event, a log of the confirmation, and the identity event in a storage of the server.

15. The computing apparatus of claim 11, wherein the instructions further configure the apparatus to:
provide an administrator configuration user interface to a client device of an administrator of the IAM system,
wherein the administrator configuration user interface enables the administrator to add users, change user roles, change user groups, grant rights permissions, or delete users.

16. The computing apparatus of claim 11, wherein the log data comprises:
log history data of changes, deletions, and modification of the IAM system; and
baseline data indicate current permissions, roles, users, and groups for the IAM system.

17. The computing apparatus of claim 16, wherein forming the anomalous detection model comprises:
form an unsupervised or supervised model based the log history data and the baseline data.

18. The computing apparatus of claim 16, wherein forming the malicious detection model comprises:
form an unsupervised or supervised model based the log history data and the baseline data.

19. The computing apparatus of claim 11, wherein the instructions further configure the apparatus to an endpoint API receptor module configured to receive all identity events from the IAM system.

20. A non-transitory computer-readable storage medium, the computer-readable storage medium including instructions that when executed by a computer, cause the computer to:
access, at a server, identity access management data from a remote identity and access management (IAM) system, the access management data comprising log data and rule data, the log data indicating identity events;
form a log model based on the log data;
form a rule model based on the rule data;
form an anomalous detection model based on the log model and the identity access management data;
form a malicious detection model based on the rule model and the identity access management data;
form a rule engine based on a manual identification of flagged IAM policies;
compute an anomalous detection score for an identity event based on the anomalous detection model;
compute a malicious detection score for the identity event based on the malicious detection model;
compute a rule engine score for the identity event based on the rule engine;
calculate a zero trust identity governance and administration (IGA) score for the identity event based on an aggregation of the anomalous detection score, the malicious detection score, and the rule engine score; and
determine whether to attest the identity event based on the zero trust IGA score and a threshold score.
